(19) United States
(12) Patent Application Publication
(10) Pub. No.: US 2019/0234818 A1
(43) Pub. Date: Aug. 1, 2019

(54) PRESSURE SENSOR

(71) Applicant: NISSHA CO., LTD., Kyoto-shi, Kyoto (JP)

(72) Inventors: Hideaki NADA, Kyoto-shi, Kyoto (JP); Atsuo INOUE, Kyoto-shi, Kyoto (JP)

(21) Appl. No.: 16/344,002

(22) PCT Filed: Oct. 31, 2017
(86) PCT No.: PCT/JP2017/039432

§ 371 Date: Apr. 22, 2019

(30) Foreign Application Priority Data
Nov. 22, 2016 (JP) 2016-227145

(51) Int. Cl. G01L 5/00; G06F 3/041

(52) U.S. Cl. CPC G01L 5/0052; G06F 3/0414; G01L 5/0028

(57) ABSTRACT

A pressure sensor includes a first insulating base material, a common electrode formed to extend on a principal surface of the first insulating base material, a second insulating base material disposed to face the principal surface of the first insulating base material, a plurality of individual electrodes provided in a paved manner facing the common electrode, over a principal surface of the second insulating base material on a side of the first insulating base material, a pressure sensitive layer overlaid on at least one of the plurality of individual electrodes and the common electrode, a plurality of thin film transistors provided on a side opposite to the principal surface of the second insulating base material, and first individual spacers and second individual spacers disposed among the plurality of individual electrodes on the principal surface of the second insulating base material to face the common electrode.

### TECHNICAL FIELD

The present invention relates to a pressure sensor and particularly relates to a pressure sensor having a pressure sensitive layer and multiple thin film transistors as electrodes.

### BACKGROUND ART

Known pressure sensors have a pressure sensitive resin combined with multiple thin film transistors (see, for example, PTL 1).

The pressure sensitive resin is formed by dispersing conductive particles in an insulating resin such as silicone rubber. A pressure applied to the pressure sensitive resin causes conductive particles in the insulating resin to come in contact with each other, thus decreasing the resistance value of the pressure sensitive resin. This allows for the detection of the pressure applied to the pressure sensitive resin.

Multiple thin film transistors, which are arranged in a matrix pattern, function as electrodes. This makes it possible to facilitate a speed-up in detection of pressure, high resolution, and reduction of power consumption.

### CITATION LIST

### Patent Literature

PTL 1: JP 2016-4940 A

### SUMMARY OF INVENTION

### Technical Problem

There is also known a pressure sensor in which a pressure sensitive layer is provided being opposite to a plurality of electrodes with a predefined gap in between.

A pressure sensor, which utilizes a change in the contact area of the pressure sensitive layer, normally has a disadvantage of the narrow pressure measurement range of the pressure sensitive layer. More specifically, in the pressure-electric resistance characteristics, the pressure sensor, in a range of low pressure, has a large change rate of electric resistance, while in a range of high pressure, the pressure sensor has a small change rate of electric resistance. This is because, despite the increase in the pressure, the contact area of the pressure sensitive layer with the electrodes does not increase in midcourse, that is, the contact resistance does not follow the pressure. This prevents, in a range of high pressure, the pressure from being accurately measured due to insufficient sensitivity.

Further, the pressure concentrates on a plurality of individual electrodes to cause the individual electrodes to be easily damaged, resulting in a low durability of the pressure sensor.

An object of the present invention is to extend a pressure measurement range enabling an accurate measurement to be performed in a pressure sensor having a plurality of electrodes that are arranged with gaps in between.

Another object of the present invention is to increase the durability of the pressure sensor.

### Solution to Problem

Some aspects are described below as the means to solve the problems. These aspects can be combined optionally, as needed.

A pressure sensor according to one aspect of the present invention includes a first insulating base material, a common electrode, a second insulating base material, a plurality of individual electrodes, a pressure sensitive layer, a plurality of thin film transistors, first individual spacers, and second individual spacers.

The common electrode is formed to extend the principal surface of the first insulating base material.

The second insulating base material is disposed to face the principal surface of the first insulating base material.

The plurality of individual electrodes are provided in a paved manner facing the common electrode, over the principal surface of the second insulating base material on the side of the first insulating base material.

The pressure sensitive layer is overlaid on at least one of the plurality of individual electrodes and the common electrode.

The plurality of thin film transistors are provided on the side opposite to the principal surface of the second insulating base material, the plurality of thin film transistors are associated with the plurality of individual electrodes, and one, or two or more adjacent thin film transistors is connected to one individual electrode.

The first individual spacers and the second individual spacers are disposed among the plurality of individual electrodes on the principal surface of the second insulating base material to face the common electrode.

The second individual spacers are formed higher than the first individual spacers.

The plurality of individual electrodes includes a low-pressure individual electrode and a high-pressure individual electrode. The low-pressure individual electrode is configured to have electrical continuity with the common electrode by just exerting of a low pressure on the low-pressure individual electrode to make the first insulating base material and the second insulating base material come close to each other, according to arrangment of the first individual spacers and the second individual spacers that are circumjacent to the low-pressure individual electrode. The high-pressure individual electrode is configured to have no electrical continuity with the common electrode by exerting of a low pressure on the high-pressure individual electrode to make the first insulating base material and the second insulating base material come close to each other and configured to have electrical continuity with the common electrode by exerting of a high pressure on the high-pressure individual electrode to make the first insulating base material and the second insulating base material come close to each other, according to arrangment of the the first individual spacers and the second individual spacers that are circumjacent to the high-pressure individual electrode.

The pressure sensor is configured such that the first individual spacers and the second individual spacers are provided to prevent a pressure from concentrating on the plurality of individual electrodes. This allows for an increase in the durability of the pressure sensor.

The pressure sensor is configured such that the low-pressure individual electrode alone, in case of low pressure, has electrical continuity with the common electrode. This makes it possible to accurately measure a resistance change (that is, a pressure) of the pressure sensitive layer through the low-pressure individual electrode. The high-pressure individual electrode is then inhibited, depending on the arrangement of the first individual spacers and the second individual spacers, from electrically contacting the common electrode compared to the low-pressure individual electrode, and thus the high-pressure individual electrode has no electrical continuity with the common electrode. Then, the increase in the pressure causes the high-pressure individual electrode to have electrical continuity with the common electrode in addition to the low-pressure individual electrode. This makes it possible to accurately measure a resistance change (that is, a pressure) of the pressure sensitive layer through the high-pressure individual electrode. This is due to a shift to higher pressure side of the pressure measurement range of the high-pressure individual electrode, which enables the electric resistance to be accurately measured, than the pressure measurement range of the low-pressure individual electrode.

The high-pressure individual electrode may be provided adjacent to the second individual spacers.

The high-pressure individual electrode may be provided being interposed between the second individual spacers.

### Advantageous Effects of Invention

The pressure sensor according to the present invention allows for an extension of a pressure measurement range enabling an accurate measurement to be performed.

### BRIEF DESCRIPTION OF DRAWINGS

FIG. 1 is a cross-sectional view schematically illustrating a pressure sensor according to a first embodiment of the present invention.

FIG. 2 is a cross-sectional view schematically illustrating a pressure sensor according to a first embodiment of the present invention.

FIG. 3 is a cross-sectional view schematically illustrating a pressure sensor according to a first embodiment of the present invention.

FIG. 4 is a partial cross-sectional view schematically illustrating a pressure sensor.

FIG. 5 is a plan view schematically illustrating a lower-side electrode member of a pressure sensor.

FIG. 6 is an equivalent circuit diagram of a pressure sensor.

FIG. 7 is a plan view schematically illustrating a planar positional relationship between individual electrodes and individual spacers.

FIG. 8 is a graph illustrating the relationship between pressure and electric resistance of a pressure sensor.

FIG. 9 is a cross-sectional view schematically illustrating a method of manufacturing a pressure sensor.

FIG. 10 is a cross-sectional view schematically illustrating a method of manufacturing a pressure sensor.

FIG. 11 is a cross-sectional view schematically illustrating a method of manufacturing a pressure sensor.

FIG. 12 is a cross-sectional view schematically illustrating a method of manufacturing a pressure sensor.

FIG. 13 is a cross-sectional view schematically illustrating a method of manufacturing a pressure sensor.

FIG. 14 is a cross-sectional view schematically illustrating a method of manufacturing a pressure sensor.

FIG. 15 is a cross-sectional view schematically illustrating a method of manufacturing a pressure sensor.

FIG. 16 is a cross-sectional view schematically illustrating a method of manufacturing a pressure sensor.

FIG. 17 is a cross-sectional view schematically illustrating a method of manufacturing a pressure sensor.

FIG. 18 is a cross-sectional view schematically illustrating a method of manufacturing a pressure sensor.

FIG. 19 is a cross-sectional view schematically illustrating a method of manufacturing a pressure sensor.

FIG. 20 is a plan view schematically illustrating planar shapes of individual electrodes and individual spacers (second embodiment).

FIG. 21 is a plan view schematically illustrating a planar positional relationship between individual electrodes and individual spacers (third embodiment).

FIG. 22 is a plan view schematically illustrating a planar positional relationship between individual electrodes and individual spacers (fourth embodiment).

FIG. 23 is a partial cross-sectional view schematically illustrating a pressure sensor (fifth embodiment).

FIG. 24 is a partial cross-sectional view schematically illustrating a pressure sensor (sixth embodiment).

FIG. 25 is a partial cross-sectional view schematically illustrating a pressure sensor (seventh embodiment).

### DESCRIPTION OF EMBODIMENTS

### 1. First Embodiment

### (1) Basic Configuration of Pressure Sensor

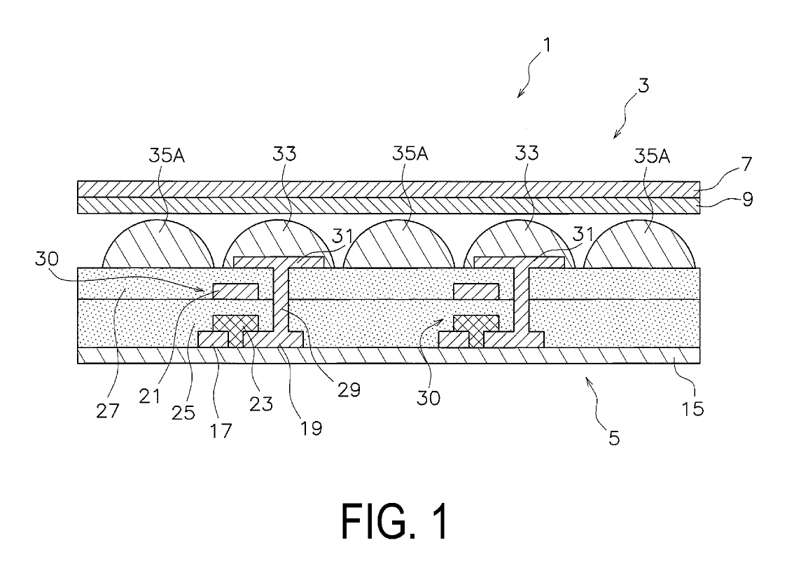

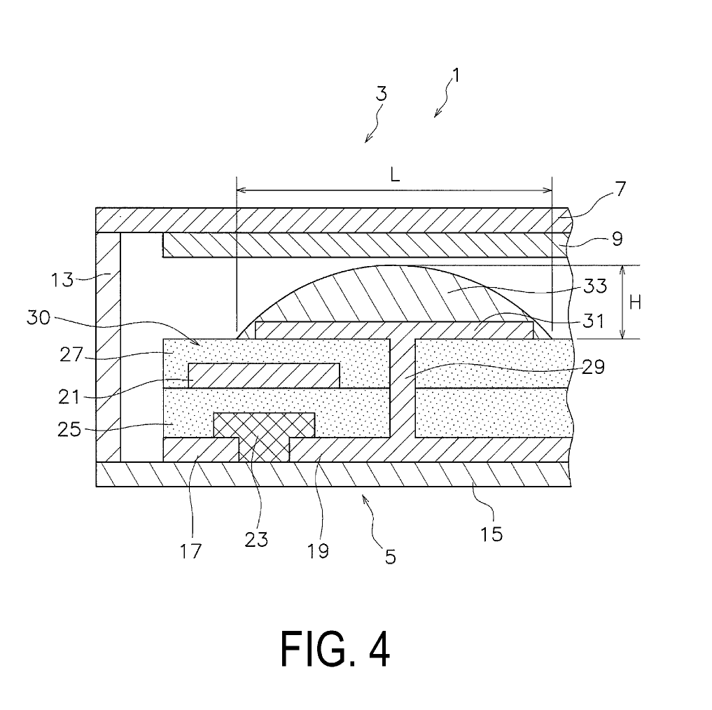

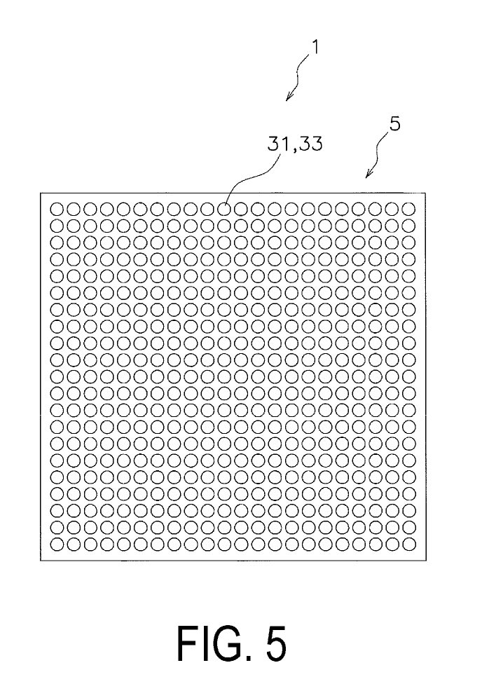

A pressure sensor 1 according to the first embodiment will be described with reference to FIGS. 1 to 5. FIGS. 1 to 3 are cross-sectional views schematically illustrating the pressure sensor according to the first embodiment of the present invention. FIG. 4 is a partial cross-sectional view schematically illustrating the pressure sensor. FIG. 5 is a plan view schematically illustrating a lower-side electrode member of the pressure sensor.

The pressure sensor 1 is a device configured to detect a pressing position and a pressing force upon an application of the pressing force to the pressure sensor 1. The pressure sensor 1 is employed, for example, for a touch panel of a smartphone, a tablet PC, or a notebook PC.

The pressure sensor 1 includes an upper-side electrode member 3. The upper-side electrode member 3 defines a planar member on which a pressing force is applied. The upper-side electrode member 3 includes an insulating film 7 (an example of the first insulating base material) and a common electrode 9 formed entirely on a lower surface (an example of the principal surface) of the insulating film 7, that is, extended or patterned all around the lower surface.

The pressure sensor 1 includes a lower-side electrode member 5. The lower-side electrode member 5 defines a planar member disposed below the upper-side electrode member 3. The lower-side electrode member 5 includes, for example, an insulating film 15 in a rectangular shape and a plurality of individual electrodes 31. The individual electrode is also referred to as a pixel electrode.

The lower-side electrode member 5 includes a plurality of mound-shaped pressure sensitive layers 33. The plurality of mound-shaped pressure sensitive layers 33 are each formed on each of the plurality of individual electrodes 31 on the side of the common electrode 9. To briefly describe, the mound-shaped pressure sensitive layer 33 entirely covers the individual electrode 31, which has an outer diameter slightly larger than the outer diameter of the individual electrode 31. Thus, the individual electrode 31 is hidden in a plan view by the mound-shaped pressure sensitive layer 33.

Note that the “mound shape” has a top portion (or central portion) and a peripheral portion, and the “mound shape” encompasses a dome shape, a cone shape, and a frustum shape. The mound shape in a plan view encompasses circle, square, and other shapes.

As an example, a height H of the mound-shaped pressure sensitive layer 33 ranges from 5 to 100 μm in a wide range and from 10 to 30 μm in a narrow range. A diameter L of the mound-shaped pressure sensitive layer 33 ranges from 0.1 to 1.0 mm in a wide range and from 0.3 to 0.6 mm in a narrow range.

As illustrated in FIG. 4, the upper-side electrode member 3 and the lower-side electrode member 5 are bonded together by a frame spacer 13 at the peripheral portion. The frame spacer 13, which defines a frame shape, is composed of, for example, an adhesive or a double-sided tape.

As illustrated in FIG. 5, the plurality of individual electrodes 31 and the mound-shaped pressure sensitive layers 33 are arranged in a paved manner over a planar surface. A first individual spacer 35A and a second individual spacer 35B to be described below are disposed between two of the plurality of individual electrodes 31 and the plurality of the mound-shaped pressure sensitive layers 33. However, in order to avoid complicated descriptions, the reference signs of the first individual spacer 35A and the second individual spacer 35B are omitted in FIG. 5.

In the first embodiment, the plurality of individual electrodes 31 and, the mound-shaped pressure sensitive layers 33, the first individual spacers 35A, and the second individual spacers 35B are arranged in a matrix pattern. The matrix pattern represents a state in which a pattern is two-dimensionally arranged like a matrix or a state similar to the state.

The region of the common electrode 9 is depressed toward the mound-shaped pressure sensitive layer 33 to allow the common electrode 9 to have electrical continuity with the individual electrode 31 allocated in the depressed region. The depressing operation may be performed, for example, with a finger, a stylus pen, a stick, a palm of a hand, or a sole of a foot. The electrode pitch ranges, for example, from 0.3 to 0.7 mm.

The lower-side electrode member 5 includes a plurality of thin film transistors 30 (each hereinafter referred to as “TFT 30”). Each of the TFT 30 is provided associated with one of the individual electrodes 31 and functions to be an electrode for detecting a current value.

### (2) Relation Between TFT and Individual Electrode

As illustrated in FIGS. 1 to 4, the TFT 30 includes a source electrode 17, a drain electrode 19, and a gate electrode 21. The TFT 30 is of a top gate-type. Materials for forming the gate electrode, the source electrode, and the drain electrode are not limited to specific materials. The TFT may be of a bottom gate-type.

The source electrode 17 and the drain electrode 19 are formed on the upper surface of the insulating film 15. The TFT 30 includes an organic semiconductor 23 formed between the source electrode 17 and the drain electrode 19. Materials for forming such a semiconductor layer include known materials such as silicon, oxide semiconductor, and organic semiconductor.

The TFT 30 includes a first insulating film 25 formed to cover the source electrode 17, the drain electrode 19, and the organic semiconductor 23.

The drain electrode 19 is connected to the individual electrode 31 as described below. The gate electrode 21 is formed on the upper surface of the first insulating film 25 over the organic semiconductor 23.

The TFT 30 includes a second insulating film 27 formed on the upper surface of the first insulating film 25 to cover the gate electrode 21.

The plurality of individual electrodes 31 are formed on the upper surface of the second insulating film 27 (an example of the second insulating base material). The individual electrode is connected to the TFT 30 via a conductive portion 29 formed in a through hole passing through the first insulating film 25 and the second insulating film 27.

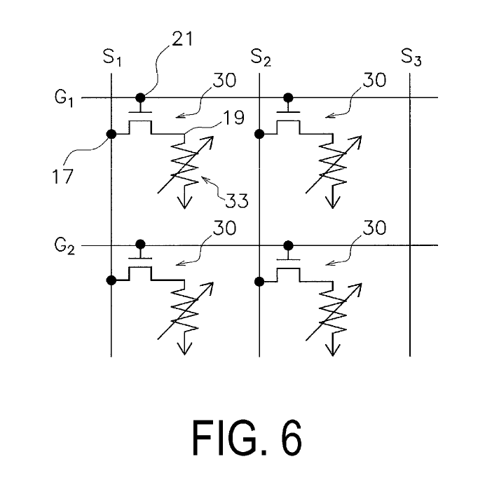

An operating principle of the pressure sensor 1 will be described with reference to FIG. 6. FIG. 6 is an equivalent circuit diagram of the pressure sensor.

An application of a voltage to the drain electrode 19 of the TFT 30 to which the gate voltage is input leads to a flow of a drain current corresponding to the resistance of the mound-shaped pressure sensitive layer 33. Then, the pressure applied to the mound-shaped pressure sensitive layer 33 increases to decrease the resistance, whereby an increase in the drain current is detected. A gate voltage is applied to the TFT 30 on the pressure sensor 1 by sweeping the TFT 30 to measure the drain current, which makes it possible to observe the pressure distribution on a sheet surface.

The pressure sensor 1 includes a circuit section (not illustrated). The circuit section is configured to control the drain electrode 19, the source electrode 17, and the common electrode 9, and the circuit section includes, for example, a power supply voltage configured to apply a predefined voltage to the common electrode 9 and the source electrode 17; and a current detection circuit configured to generate a signal according to a current value between the source and the drain and to output the signal to an external signal processing device. The external signal processing device is configured to detect the pressing position and the pressing force on the basis of the signal being transmitted from the circuit section.

### (3) Individual Spacer

As illustrated in FIGS. 1 to 3, on the upper surface of the lower-side electrode member 5, a plurality of individual spacers (each also referred to as dummy electrode), more specifically, the first individual spacers 35A and the second individual spacers 35B are formed among the individual electrodes 31 and the mound-shaped pressure sensitive layers 33.

The first individual spacer 35A and the second individual spacer 35B each define a mound shape like the mound-shaped pressure sensitive layer 33. The first individual spacer 35A has the same height as the mound-shaped pressure sensitive layer 33 and creates a gap with the common electrode 9. However, the first individual spacer 35A may be formed higher than the mound-shaped pressure sensitive layer 33.

The height of the first individual spacer 35A and the second individual spacer 35B and the gap at the individual electrode 31 may be appropriately set from a wide range. For example, the gap at the individual electrode 31 may range from 0 to several tens of micrometers and may be on the order of several micrometers or several tens of micrometers.

The second individual spacer 35B is formed higher than the first individual spacer 35A. More specifically, in a case when the height of the mound-shaped pressure sensitive layer 33 is 20 μm, the height of the first individual spacer 35A is in a range of from 20 to 70 μm, and the height of the second individual spacer 35B is in a range of from 25 to 125 μm. The height ratio of the height of the first individual spacer 35A to the height of the second individual spacer 35B is in a range of from 1.07 to 3.75. Thus, the second individual spacer 35B is in contact with or in proximity to the common electrode 9. The above structure allows the gap to be reliably secured between the common electrode 9 and the mound-shaped pressure sensitive layer 33 at the time of non-pressurization, and thus the pressure to be applied on the mound-shaped pressure sensitive layer 33 can be made zero.

Note that the first individual spacer 35A and the second individual spacer 35B, each of which defines a mound shape, make the space above the circumference of the mound-shaped pressure sensitive layer 33 relatively large, which allows the common electrode 9 to easily follow the mound-shaped pressure sensitive layer 33. However, the individual spacer does not necessarily define a mound shape, and the upper surface of the individual spacer may be planarly provided.

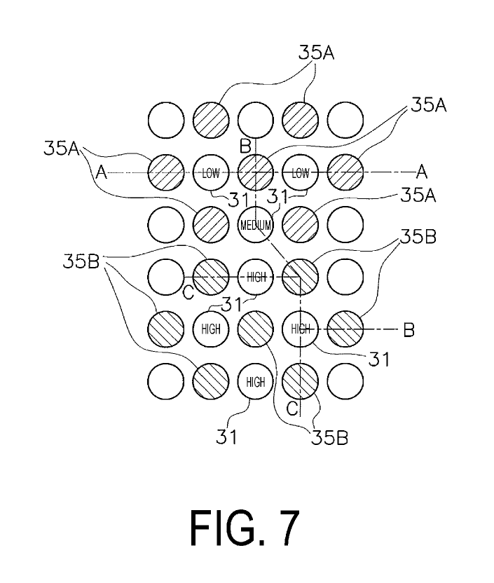

Next, a planar positional relationship among the individual electrode 31, the first individual spacer 35A, and the second individual spacer 35B will be described with reference to FIG. 7. FIG. 7 is a plan view schematically illustrating a planar positional relationship between the individual electrodes and the individual spacers. Hereinafter, the mound-shaped pressure sensitive layers 33 are actually overlaid on the individual electrodes 31, and the reference signs of the mound-shaped pressure sensitive layers 33 are omitted for simplifying the explanation.

FIG. 7 illustrates the individual electrodes 31, and the first individual spacers 35A and the second individual spacers 35B that are alternately arranged in the upper-half region and the lower-half region in the figure, respectively. That is, in each region, the individual electrodes 31 are adjacent to each other in neither the row direction nor the column direction. In each region, the respective individual spacers are adjacent to each other in neither the row direction or the column direction. However, at the boundary of the regions in FIG. 7, the individual electrodes 31 are adjacent to each other in the vertical direction in the figure, and the first individual spacer 35A and the second individual spacer 35B are adjacent to each other in the vertical direction in the figure.

Note that, although it can be assumed that the pressures are concentrated at the apex of the mound due to the mound-shaped pressure sensitive layer 33 formed on the individual electrode 31, the provision of the plurality of first individual spacers 35A and the plurality of second individual spacers 35B enables the pressures to be distributed to the plurality of apexes. As a result, this enhances the durability of the pressure sensor 1.

The two individual electrodes 31 marked with a letter of “low” on the line A in FIG. 7 will be described. Note that FIG. 1 is a cross-sectional view taken along the line A in FIG. 7.

The four sides of the individual electrode 31 are surrounded by four pieces of the first individual spacers 35A. Individual electrodes 31 are arranged at four locations in diagonal directions with respect to the individual electrode 31. That is, a structure is provided such that the eight peripheral locations with respect to the individual electrode 31 are all provided at an identical height. Thus, the individual electrode 31 defines the individual electrode 31 (an example of the low-pressure individual electrode) for low-pressure measurement.

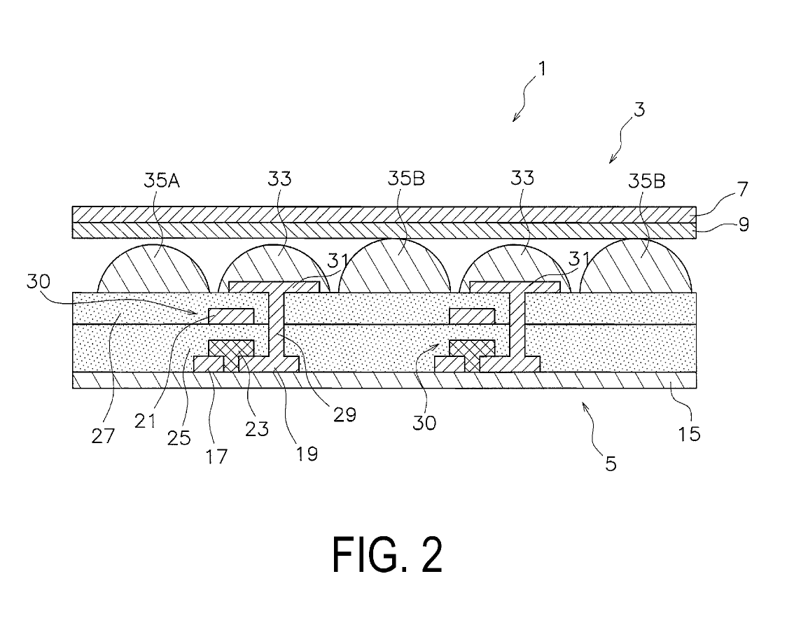

The individual electrode 31 marked with a letter of “middle” at the first location from the top on the figure in the line B in FIG. 7 will be described. Note that FIG. 2 is a cross-sectional view taken along the line B in FIG. 7. The individual electrode 31 is surrounded on all four sides by three pieces of the first individual spacers 35A and one piece of the individual electrode 31 marked with a letter of “high”. Two individual electrodes 31 are arranged at two locations in diagonal directions with respect to the individual electrode 31 and two second individual spacers 35B are arranged at the remaining two locations in diagonal directions. That is, a structure is provided such that two of the eight peripheral locations with respect to the individual electrode 31 are provided at a height higher than the individual electrode 31. Thus, the individual electrode 31 defines the individual electrode 31 for medium-pressure measurement.

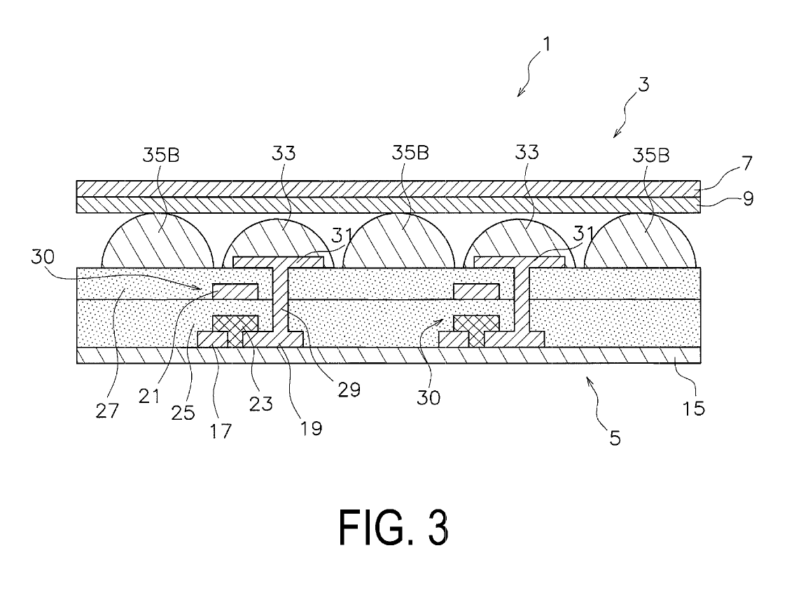

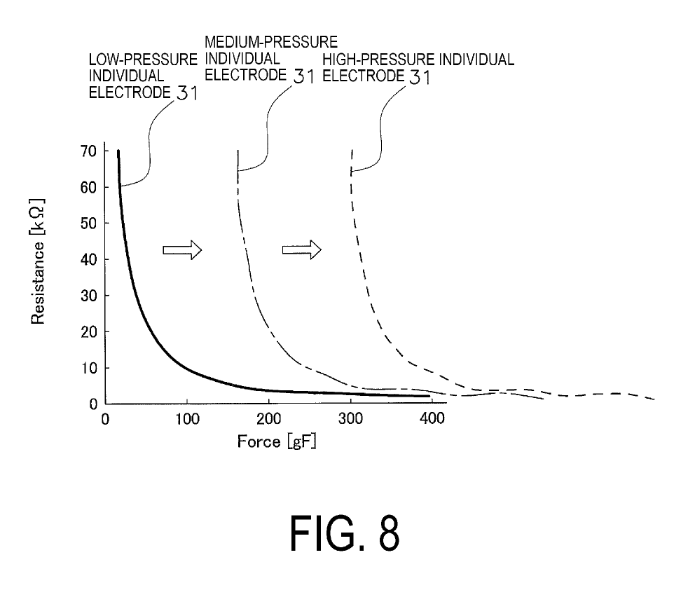

One piece of the individual electrode 31 marked with a letter of “high” on the right side in the line C in FIG. 7 will be described. Note that FIG. 3 is a cross-sectional view taken along the line C in FIG. 8. The individual electrode 31 is surrounded on all four sides by four pieces of the second individual spacers 35B. Four individual electrodes 31 are arranged at four locations in diagonal directions with respect to the individual electrodes 31. That is, a structure is provided such that four of the eight peripheral locations with respect to the individual electrode 31 are provided at a height higher than the individual electrode 31. Thus, the individual electrode 31 defines the individual electrode 31 (an example of the high-pressure individual electrode) for high-pressure measurement.

Accordingly, the plurality of high-pressure individual electrodes 31 are arranged at the lower region in the figure to form a high-pressure area, one piece of the medium-pressure individual electrode 31 is arranged at all the vertical locations in the figure, and a pair of low-pressure individual electrodes 31 are arranged in the upper partial region in the figure to form a low-pressure area.

As described above, the low-pressure individual electrode 31 is configured to have electrical continuity with the common electrode 9 by just exerting of a low pressure on the low-pressure individual electrode 31 according to arrangement of the first individual spacers 35A and the second individual spacers 35B that are circumjacent to the low-pressure individual electrode 31. The high-pressure individual electrode 31 is configured to have no electrical continuity with the common electrode 9 by exerting of a low or medium pressure on the high-pressure individual electrode 31 and configured to have electrical continuity with the common electrode 9 by exerting of a high pressure on the high-pressure individual electrode 31, according to arrangment of the first individual spacers 35A and the second individual spacers 35B that are circumjacent to the high-pressure individual electrode 31. The medium-pressure individual electrode 31 is configured to have no electrical continuity with the common electrode 9 by exerting of a low pressure on the medium-pressure individual electrode 31 and configured to have electrical continuity with the common electrode 9 by exerting of a medium pressure on the medium-pressure individual electrode 31, according to arrangment of the first individual spacers 35A and the second individual spacers 35B that are circumjacent to the medium-pressure individual electrode 31.

To describe more specifically, each individual electrode 31 is determined to be compatible with any one of the pressure ranges, depending on the density, distance, and height of the second individual spacers 35B disposed circumjacent to the individual electrode 31. That is, each individual electrode 31 has electrical continuity with the common electrode 9 even in case of low pressure when ensuring a high “easiness in contact at low pressure” due to a reason such as a small number of the second individual spacers 35B disposed circumjacent to the individual electrode 31. Further, for example, each individual electrode 31 has no electrical continuity with the common electrode 9 in case of low pressure when ensuring a low “easiness in contact at low pressure” due to a reason such as a large number of the second individual spacers 35B disposed circumjacent to the individual electrode 31, while each individual electrode 31 has electrical continuity with the common electrode 9 after the pressure reaches a high pressure.

### (4) Pressing Operation and Pressure Measuring Operation

pressing operation and pressure measuring operation will be described with reference to FIG. 8. FIG. 8 is a graph illustrating a relationship between pressure and the electric resistance of the pressure sensor.

As illustrated in FIG. 8, pressure applied to the mound-shaped pressure sensitive layer 33 decreases the resistance of the mound-shaped pressure sensitive layer 33. The potential difference between the source and the drain when a constant voltage is applied by a voltage power source varies depending on the resistance value of the mound-shaped pressure sensitive layer 33 that is serially connected to the drain electrode 19. This allows the potential difference between the source and the drain to increase, increasing the amount of current flow. Thus, the pressing force and the amount of current to be provided to the mound-shaped pressure sensitive layer 33 acquired in advance allow the signal processing device (not illustrated) to read out the signals varying in accordance with the amount of current, resulting in the detection of the pressure (pressing force) to be applied to the pressure sensor 1.

A small force exerted on the upper-side electrode member 3 causes the common electrode 9 to come in contact with the low-pressure individual electrode 31 (more specifically, the mound-shaped pressure sensitive layer 33) alone. Thus, as illustrated in FIG. 8, an output from the TFT 30 associated with the individual electrode 31 allows the low pressure to be accurately measured. A medium force exerted on the upper-side electrode member 3 causes the common electrode 9 to also come in contact with the medium-pressure individual electrode 31 (more specifically, the mound-shaped pressure sensitive layer 33). Thus, as illustrated in FIG. 8, an output from the TFT 30 associated with the individual electrode 31 allows the medium pressure to be accurately measured.

A large force exerted on the upper-side electrode member 3 causes the common electrode 9 to also come in contact with the high-pressure individual electrode 31 (more specifically, the mound-shaped pressure sensitive layer 33). Thus, as illustrated in FIG. 8, an output from the TFT 30 associated with the individual electrode 31 allows the high pressure to be accurately measured.

As described above, the regions where the rate of the resistance change of each electrode is amply high, which are displaced in accordance with the load, allows any of low pressure, medium pressure, and high pressure to be accurately measured.

The pressure sensor 1 includes a pressing region. The pressing region may be the entirety or a part of the pressure sensor 1.

In any of the pressed places in the pressing region, the low-pressure individual electrode 31, the medium-pressure individual electrode 31, and the high-pressure individual electrode 31 are arranged to be included within a minimum pressing area.

The “minimum pressing area” represents the minimum area that is supposed to be inevitably pressed when a possible pressing object (for example, a finger or a pen) presses the pressure sensor.

### (5) Material

The insulating film 7 and the insulating film IS may be formed by using: an engineering plastics such as polycarbonate-based plastics, polyamide-based plastics, or polyether ketone-based plastics; or a resin film such as acrylic-based resin film, polyethylene terephthalate-based resin film, or polybutylene terephthalate-based resin film.

In a case when stretching properties are required for the insulating film 7, urethane film, silicon, or rubber may be used. The insulating film 7 and the insulating film 15 formed of heat resistant materials are favorably used because the electrodes are formed by printing and then drying.

The common electrode 9 and the individual electrode 31 may be formed by using: a metal oxide film such as tin oxide, indium oxide, antimony oxide, zinc oxide, cadmium oxide, or indium tin oxide (ITO) film; a composite mainly composed of these metal oxide films; or a metal film such as gold, silver, copper, tin, nickel, aluminum, or palladium film. In a case when stretching properties are required for the common electrode 9, a stretchable Ag paste may be used, for example.

The mound-shaped pressure sensitive layer 33 is composed of, for example, a pressure-sensitive ink. The pressure-sensitive ink is a material that enables the detection of pressure due to variation in the contact resistance with the opposing electrode in accordance with an external force. The pressure-sensitive ink layer may be disposed by coating. The coating method of the pressure-sensitive ink layer includes a printing method such as screen printing, offset printing, gravure printing, or flexographic printing; or an application by a dispenser may be used.

The first individual spacer 35A and the second individual spacer 35B may be formed by using a printed layer or a coated layer of a resin such as acrylic resin, epoxy resin, or silicone resin.

### (6) Method of Manufacturing Pressure Sensor

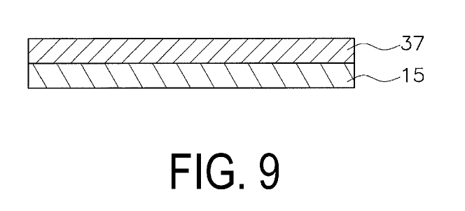

A method of manufacturing the pressure sensor 1 will be described with reference to FIGS. 9 to 19. FIGS. 9 to 19 are cross-sectional views schematically illustrating a method of manufacturing a pressure sensor.

First, each of the steps in a method of manufacturing the lower-side electrode member 5 will be described with reference to FIGS. 9 to 18.

As illustrated in FIG. 9, an electrode material 37 is formed on one surface of the insulating film 15 by, for example, sputtering.

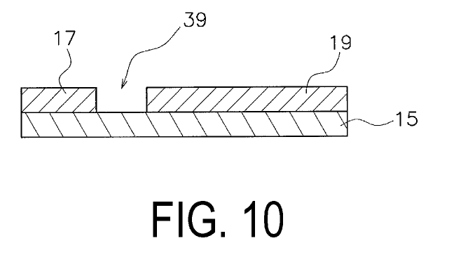

As illustrated in FIG. 10, the electrode material 37 is partially removed by, for example, a photolithography method, to thus form a film exposed portion 39. The source electrode 17 and the drain electrode 19 are thereby formed. Note that the source electrode 17 and the drain electrode 19 may be formed without being limited to a specific method.

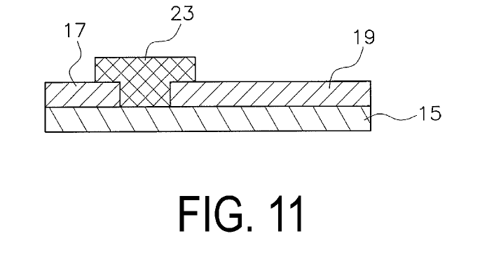

As illustrated in FIG. 11, the organic semiconductor 23 is formed in the film exposed portion 39. The organic semiconductor 23 is formed by using a known technique.

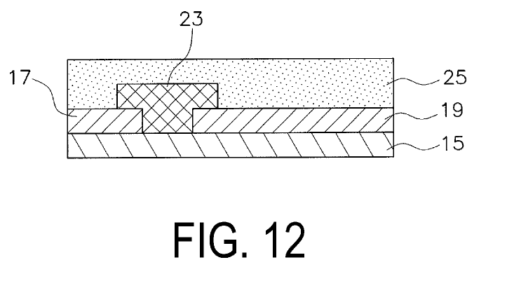

As illustrated in FIG. 12, the first insulating film 25 is formed to cover the surface on which the source electrode 17, the drain electrode 19, and the organic semiconductor 23 are formed.

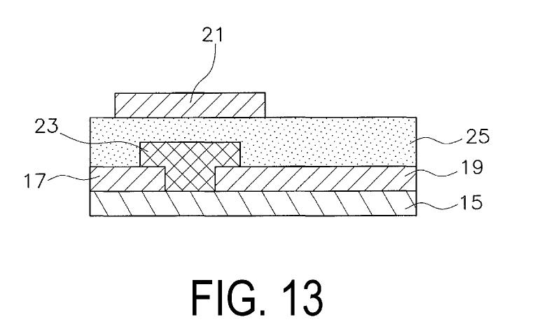

As illustrated in FIG. 13, the gate electrode 21 is formed on the upper surface of the first insulating film 25 over the organic semiconductor 23. The gate electrode 21 is formed by using a known technique.

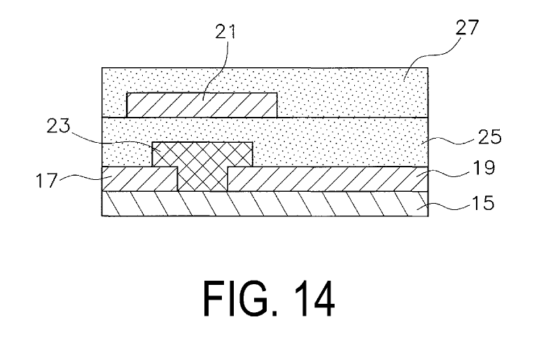

As illustrated in FIG. 14, the second insulating film 27 is formed to cover the entirety of the first insulating film 25 on which the gate electrode 21 is formed.

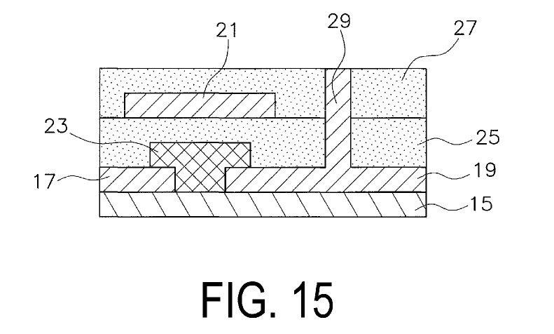

As illustrated in FIG. 15, a laser is used to form a through hole through the first insulating film 25 and the second insulating film 27 to the drain electrode 19, and a conductive material is filled in the through hole to form the conductive portion 29.

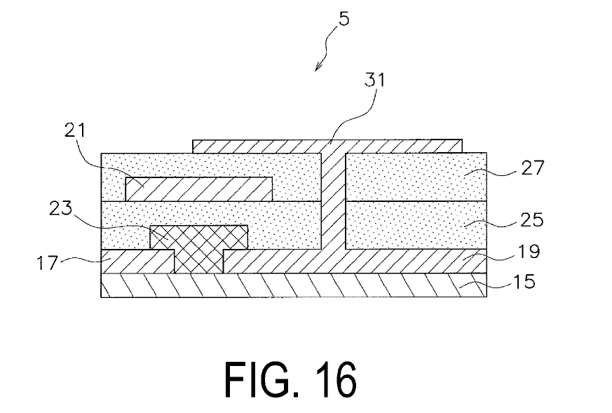

As illustrated in FIG. 16, the individual electrode 31 is formed by a printing method and is then connected to the TFT 30 via the conductive portion 29.

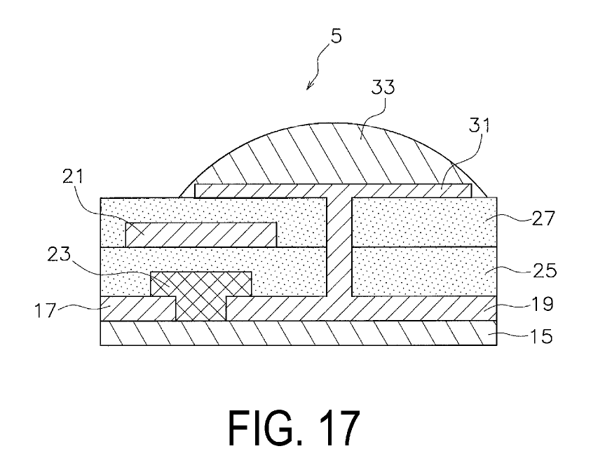

As illustrated in FIG. 17, the mound-shaped pressure sensitive layer 33 is formed by a printing method on the individual electrode 31.

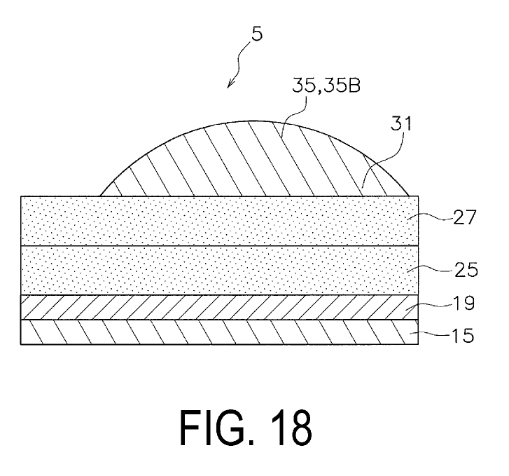

Further, as illustrated in FIG. 18, the first individual spacer 35A and the second individual spacer 35B are formed by a printing method on the second insulating film 27.

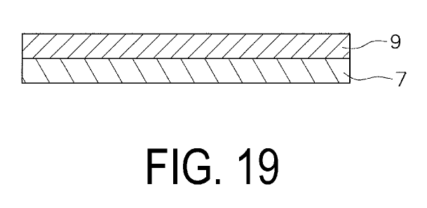

Next, the manufacture of the upper-side electrode member 3 will be described with reference to FIG. 19.

As illustrated in FIG. 19, the common electrode 9 is formed by a printing method on one surface of the insulating film 7. Note that a material for the common electrode 9 may be formed, for example, by sputtering, on one surface of the insulating film 7 to then form the common electrode 9 by a photolithography method.

Lastly, the upper-side electrode member 3 and the lower-side electrode member 5 are bonded together via the frame-shaped frame spacer 13 (FIG. 4) composed of an adhesive, to thus finish forming the pressure sensor 1.

### 2. Second Embodiment

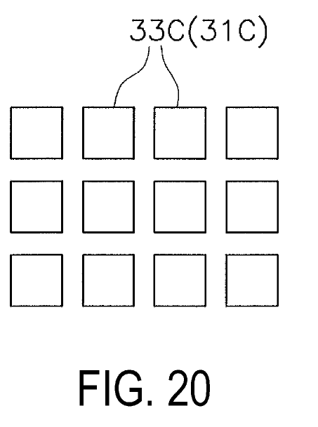

In the first embodiment described above, the planar shape of the individual electrode 31 and the mound-shaped pressure sensitive layer 33 both define a circular shape, but may define any other shape. Such an embodiment will be described with reference to FIG. 20. FIG. 20 is a plan view schematically illustrating planar shapes of individual electrodes and individual spacers.

FIG. 20 illustrates an individual electrode 31C and a mound-shaped pressure sensitive layer 33C each having a planar shape of a quadrangle. The planar shapes may be a triangle or other polygon.

### 3. Third Embodiment

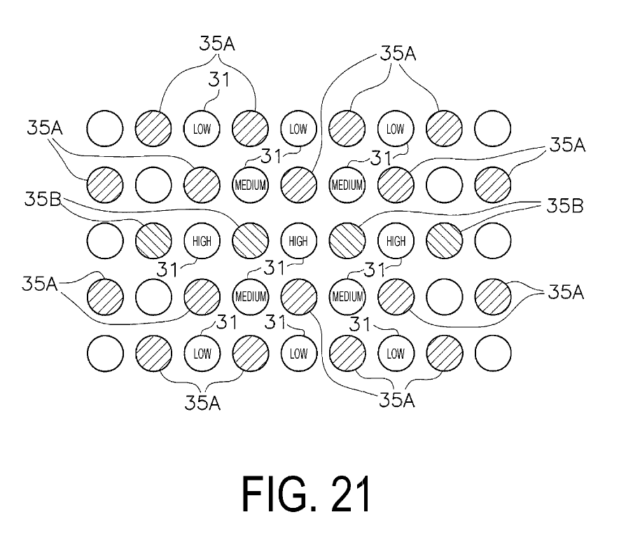

Modifications of the arrangement pattern of the individual electrodes 31, and the first individual spacers 35A and the second individual spacers 35B will be described with reference to FIG. 21. FIG. 21 is a plan view schematically illustrating a planar positional relationship between the individual electrodes and the individual spacers.

FIG. 21 illustrates the individual electrode 31; and the first individual spacer 35A and the second individual spacer 35B that are alternately arranged. That is, the respective individual electrodes 31 are adjacent to each other in neither the row direction nor the column direction. The respective individual spacers are adjacent to each other in neither the row direction nor the column direction.

FIG. 21 illustrates the second individual spacers 35B linearly arranged in a horizontal manner at the center in the vertical direction of the figure. Thus, the individual electrode 31 marked with a letter of “high” interposed between the respective second individual spacers 35B defines a high-pressure individual electrode, the individual electrode 31 marked with a letter of “medium” not interposed between the respective second individual spacers 35B but arranged adjacent to the second individual spacers 35B defines a medium-pressure individual electrode, and the individual electrode 31 marked with a letter of “low” spaced apart from the second individual spacer 35B defines a low-pressure individual electrode.

Accordingly, the plurality of high-pressure individual electrodes 31 are arranged at the middle in the vertical direction of the figure, the plurality of medium-pressure individual electrodes 31 are arranged on the upper and lower outer sides of the plurality of high-pressure individual electrodes 31, and the plurality of low-pressure individual electrodes 31 are arranged on the upper and lower outer sides of the plurality of medium-pressure individual electrodes 31.

In the third embodiment as well, the low-pressure individual electrode 31 is configured to have electrical continuity with the common electrode 9 by just exerting of a low pressure on the low-pressure individual electrode 31 according to arrangement of the first individual spacers 35A and the second individual spacers 358 that are circumjacent to the low-pressure individual electrode 31. The high-pressure individual electrode 31 is configured to have no electrical continuity with the common electrode 9 by exerting of a low or medium pressure on the high-pressure individual electrode 31 and configured to have electrical continuity with the common electrode 9 by exerting of a high pressure on the high-pressure individual electrode 31, according to arrangment of the first individual spacers 35A and the second individual spacers 35B that are circumjacent to the high-pressure individual electrode 31. The medium-pressure individual electrode 31 is configured to have no electrical continuity with the common electrode 9 by exerting of a low pressure on the medium-pressure individual electrode 31 and configured to have electrical continuity with the common electrode 9 by exerting of a medium pressure on the medium-pressure individual electrode 31, according to arrangment of the first individual spacers 35A and the second individual spacers 35B that are circumjacent to the medium-pressure individual electrode 31.

### 4. Fourth Embodiment

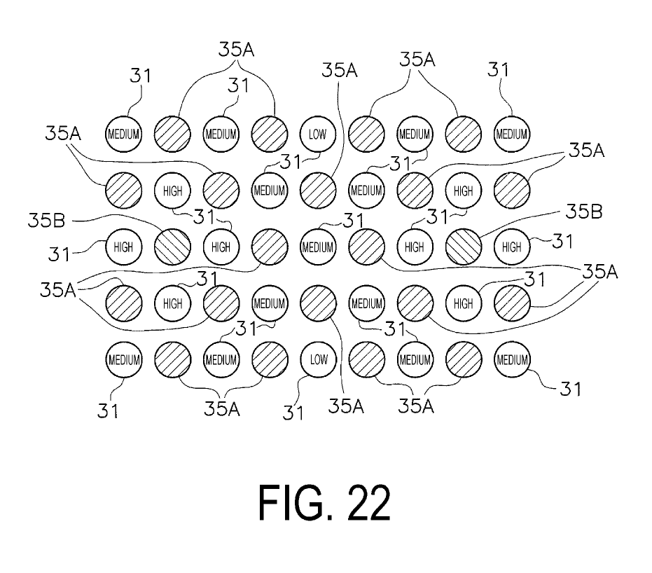

Modifications of the arrangement pattern of the individual electrodes 31; and the first individual spacers 35A and the second individual spacers 35B will be described with reference to FIG. 22. FIG. 22 is a plan view schematically illustrating a planar positional relationship between the individual electrodes and the individual spacers.

FIG. 22 illustrates the individual electrode 31; and the first individual spacer 35A and the second individual spacer 35B that are alternately arranged. That is, the respective individual electrodes 31 are adjacent to each other in neither the row direction nor the column direction. Further, the respective individual spacers are adjacent to each other in neither the row direction nor the column direction.

A pair of second individual spacers 35B are spaced apart from each other in the horizontal direction of the figure. Thus, the individual electrode 31 marked with a letter of “high” circumjacent to the second individual spacer 35B defines a high-pressure individual electrode, the individual electrode 31 marked with a letter of “medium” not interposed between the respective second individual spacers 35B but arranged adjacent to the second individual spacers 35B defines a medium-pressure individual electrode, and the individual electrode 31 marked with a letter of “low” spaced apart from the second individual spacer 35B defines a low-pressure individual electrode.

Accordingly, the plurality of high-pressure individual electrodes 31 are arranged at both sides of the figure, a plurality of medium-pressure individual electrodes 31 are arranged in the entirety of the figure, and a pair of low-pressure individual electrodes 31 are arranged on the upper and lower both sides of the figure.

In the fourth embodiment as well, the low-pressure individual electrode 31 is configured to have electrical continuity with the common electrode 9 by just exerting of a low pressure on the low-pressure individual electrode 31 according to arrangment of the first individual spacers 35A and the second individual spacers 35B that are circumjacent to the low-pressure individual electrode 31. The high-pressure individual electrode 31 is configured to have no electrical continuity with the common electrode 9 by exerting of a low or high pressure on the high-pressure individual electrode 31 and configured to have electrical continuity with the common electrode 9 by exerting of a high pressure on the high-pressure individual electrode 31, according to arrangement of the first individual spacers 35A and the second individual spacers 35B that are circumjacent to the high-pressure individual electrode 31. The medium-pressure individual electrode 31 is configured to have no electrical continuity with the common electrode 9 by exerting of a low pressure on the medium-pressure individual electrode 31 and configured to have electrical continuity with the common electrode 9 by exerting of a medium pressure on the medium-pressure individual electrode 31, according to arrangement of the first individual spacers 35A and the second individual spacers 35B that are circumjacent to the medium-pressure individual electrode 31.

### 5. Fifth Embodiment

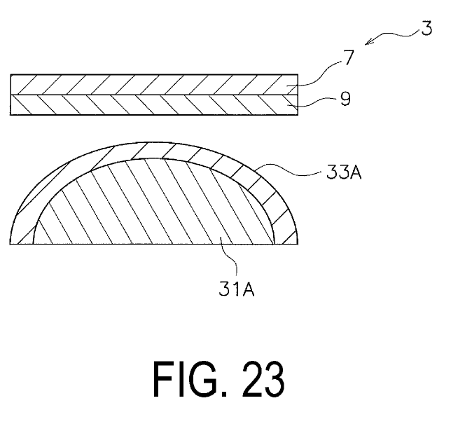

In the above-described embodiments, the individual electrode defines a flat plate shape, but may define a mound shape. Such an embodiment will be described with reference to FIG. 23. FIG. 23 is a partial cross-sectional view schematically illustrating the pressure sensor.

FIG. 23 illustrates an individual electrode 31A defining a mound shape, and a mound-shaped pressure sensitive layer 33A overlaid on the upper surface of the individual electrode 31A.

### 6. Sixth Embodiment

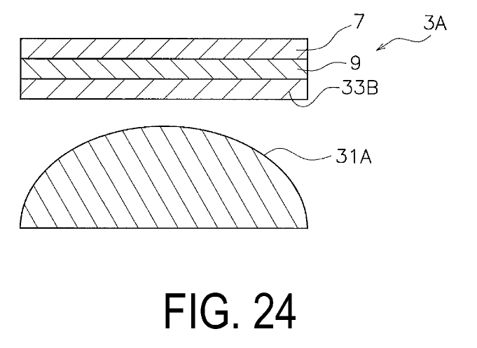

In the above-described embodiments, the pressure sensitive layer is overlaid on the individual electrode, but may be formed on the upper-side electrode member. Such an embodiment will be described with reference to FIG. 24. FIG. 24 is a partial cross-sectional view schematically illustrating the pressure sensor.

FIG. 24 illustrates an upper-side electrode member 3A including a pressure sensitive layer 33B formed on the lower surface of the common electrode 9. The individual electrode 31A defines a mound shape.

### 7. Seventh Embodiment

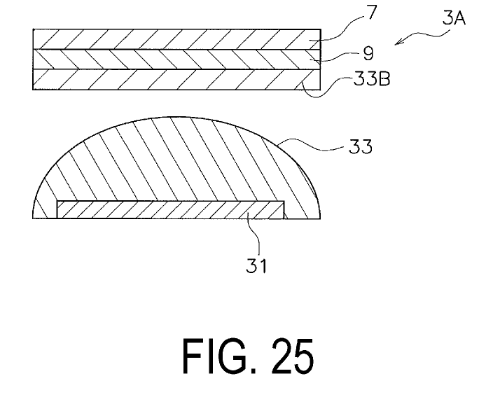

In any of the above-described embodiments, the pressure sensitive layer is formed in one of the upper-side electrode member and the lower-side electrode member, but may be formed in both of the members to be opposite to each other. Such an embodiment will be described with reference to FIG. 25. FIG. 25 is a partial cross-sectional view schematically illustrating the pressure sensor.

FIG. 25 illustrates the mound-shaped pressure sensitive layer 33 formed on the individual electrode 31. Further, the upper-side electrode member 3A includes the pressure sensitive layer 33B formed on the lower surface of the common electrode 9.

### 8. Other Embodiments

Although the plurality of embodiments of the present invention have been described as above, the present invention is not limited to the above-described embodiments, and various modifications are possible without departing from the gist of the invention. In particular, the embodiments and modifications described in this specification can be freely combined as necessary.

(1) In the above-described embodiments, the individual electrode 31; and the first individual spacer 35A and the second individual spacer 35B define a matrix pattern having rows and columns that are fully aligned, but may be arranged in a matrix pattern in terms of a broad sense.

### (2) Modifications of Side-Surface Shape of Pressure Sensitive Layer

In the above-described embodiments, although the mound-shaped pressure sensitive layer 33 defines a dome shape, and its side surface shape defines a semicircle shape, the mound-shaped pressure sensitive layer 33 and the side surface shape may define any other shape.

(3) In the above-described embodiments, the thin film transistor is associated with each individual electrode to further detect the current through each thin film transistor. In other words, one thin film transistor is coupled to one individual electrode. However, the plurality of thin film transistors may be associated with one individual electrode to detect currents through the plurality of thin film transistors. More specifically, two or more thin film transistors adjacent to one individual electrode are connected to the one individual electrode. This allows the current value to be detected to increase, further imparting redundancy to the circuit.

(4) In the above-described embodiments, the individual electrodes are categorized into low-pressure, medium-pressure, and high-pressure individual electrodes, but may be categorized into two types of low-pressure and high-pressure, or categorized into four or more types.

(5) In the above-described embodiments, the pressure sensitive layer defines a mound shape, but may define any other shape.

(6) In the above-described embodiments, the individual spacer is composed of a material different from the material of the individual electrode and the pressure sensitive layer, the present invention is not limited to these embodiments as long as the condition is satisfied in which the individual spacer is electrically independent from the individual electrode.

For example, the individual spacer including the individual electrode and the pressure sensitive layer may be configured to omit the inclusion of the conductive portion 29. In this case, the individual spacers are formed concurrently with the individual electrodes and the pressure sensitive layers in the step of forming the individual electrodes and the pressure sensitive layers.

Alternatively, for example, the individual spacer including the conductive portion 29 and the individual electrode 31 may be configured to use an insulating material in place of the mound-shaped pressure sensitive layer 33. In this case, the conductive portion 29 and the individual electrode 31 are formed at all places beforehand, and subsequently the pressure sensitive portion and the individual spacer may be formed with the mound-shaped pressure sensitive layer 33 or the insulating material.

Alternatively, the individual spacer including the conductive portion 29, the individual electrode 31, and the mound-shaped pressure sensitive layer 33 may be configured such that the conductive portion 29 has no electrical continuity with the drain electrode 19.

(7) The respective individual electrodes 31 may be adjacent to each other in either or both of the row and column directions.

The respective individual spacers may also be adjacent to each other in either or both of the row and column directions.

(8) An individual spacer being insulated may be in contact with an individual spacer or an individual electrode that is adjacent to the individual spacer.

### INDUSTRIAL APPLICABILITY

The present invention may be generally applied to a pressure sensor having a pressure sensitive layer and multiple thin film transistors as electrodes. In particular, the pressure sensor according to the present invention is suitable for a sheet sensor of large area in addition to the touch panel. More specifically, the pressure sensor according to the present invention may be applied to techniques of measuring walking (in medical, sports, or security fields), or techniques of measuring bed sores.

### REFERENCE SIGNS LIST

1i: Pressure sensor
3: Upper-side electrode member
5: Lower-side electrode member
7: Insulating film
9: Common electrode
13: Frame spacer
15: Insulating film
30: Thin film transistor
31: Individual electrode
33: Mound-shaped pressure sensitive layer
35A: First individual spacer
35B: Second individual spacer

1. A pressure sensor comprising:
a first insulating base material;
a common electrode formed to extend on a principal surface of the first insulating base material;
a second insulating base material disposed to face the principal surface of the first insulating base material;
a plurality of individual electrodes provided in a paved manner facing the common electrode, over a principal surface of the second insulating base material on a side of the first insulating base material;
a pressure sensitive layer overlaid on at least one of the plurality of individual electrodes and the common electrode;
a plurality of thin film transistors provided on a side opposite to the principal surface of the second insulating base material, the plurality of thin film transistors being associated with the plurality of individual electrodes, one, or two or more adjacent thin film transistors of the plurality of thin film transistors being connected to one individual electrode; and
first individual spacers and second individual spacers disposed among the plurality of individual electrodes on the principal surface of the second insulating base material to face the common electrode,
the second individual spacers being formed higher than the first individual spacers; and
the plurality of individual electrodes including
a low-pressure individual electrode configured to have electrical continuity with the common electrode by just exerting of a low pressure on the low-pressure individual electrode to make the first insulating base material and the second insulating base material come close to each other, according to arrangment of the first individual spacers and the second individual spacers that are circumjacent to the low-pressure individual electrode, and
a high-pressure individual electrode configured to have no electrical continuity with the common electrode by exerting of a low pressure on the high-pressure individual electrode to make the first insulating base material and the second insulating base material come close to each other and configured to have electrical continuity with the common electrode by exerting of a high pressure on the high-pressure individual electrode to make the first insulating base material and the second insulating base material come close to each other, according to arrangment of the the first individual spacers and the second individual spacers that are circumjacent to the high-pressure individual electrode.

2. The pressure sensor according to claim 1, wherein
the high-pressure individual electrode is provided adjacent to the second individual spacers.

3. The pressure sensor according to claim 2, wherein
the high-pressure individual electrode is provided interposed between the second individual spacers.
